(19) United States
(12) Patent Application Publication
(10) Pub. No.: US 2012/0113326 A1
(43) Pub. Date: May 10, 2012

(54) SYSTEM AND METHOD FOR DETECTING MOTION VECTORS IN A RECURSIVE HIERARCHICAL MOTION ESTIMATION SYSTEM USING A NON-RASTERIZED SCAN

(75) Inventors: Jyothsna Nagaraja, Sunnyvale, CA (US); Peter Dean Swartz, San Jose, CA (US)

(73) Assignee: STMicroelectronics, Inc., Carrollton, TX (US)

(21) Appl. No.: 12/939,921

(22) Filed: Nov. 4, 2010

(51) Int. Cl. H04N 5/14; H04N 7/12

(52) U.S. Cl. 348/699; 375/240.16; 375/E07.243; 348/E05.062

(57) ABSTRACT

The present disclosure provides a system and method for detecting motion vectors in an image frame using a recursive hierarchical process with a non-rasterized vector-scanning motion to reduce erroneous motion vectors in an image frame of a digital video sequence. In general, a resolution hierarchy is generated for an image frame, wherein the resolution hierarchy comprises the original image frame and one or more copy image frames each having a different, lower resolution than the original image frame. Each image frame in the hierarchy is partitioned into image patches disposed in columns and rows, and the image patches are scanned in a non-rasterized motion to detect motion vectors in each image patch. The disclosed system and method provides faster convergence and improved accuracy by converging motion vectors in multiple directions and minimizing erroneous motion vectors in the image sequence.

### BACKGROUND

1. Technical Field

The present invention relates generally to motion estimation and, more specifically, to a system and method for improved motion estimation of vectors in a video sequence using a recursive hierarchical process having a non-rasterized vector-scanning motion.

2. Introduction

In conventional motion estimation systems using block motion compensation, image frames in a digital video sequence are partitioned into blocks of pixels called image patches, wherein movement in the image frames may be represented by motion vectors located in the image patches. Recursive hierarchical motion estimation systems detect motion vectors in image patches by generating a pyramid of resolutions for an image frame and scanning the image patches in a rasterized fashion for each level within the hierarchy. A rasterized scan produces a single direction of scan for each motion vector which results in slow convergence and an abundance of erroneous motion vectors occurring predominantly on one side of object/background boundaries. Effects of these erroneous motion vectors are especially visible during object occlusion, as boundaries of objects are poorly defined due to the erroneous motion vectors. Therefore, there exists a need for a motion estimation system that provides faster convergence and greater accuracy when detecting motion vectors in image frames of a digital video sequence.

### SUMMARY

The present disclosure provides a system and method for detecting motion vectors in an image frame using a recursive hierarchical process with a non-rasterized vector-scanning motion to reduce erroneous motion vectors in an image frame of a digital video sequence. In general, a resolution hierarchy is generated for an image frame, wherein the resolution hierarchy comprises the original image frame and one or more copy image frames each having a different, lower resolution than the original image frame. Each image frame in the hierarchy is partitioned into image patches disposed in columns and rows, and the image patches are scanned in a non-rasterized motion to detect motion vectors in each image patch.

In one embodiment of the present disclosure, the image frame having a lower resolution in the resolution hierarchy is selected and scanned in a general direction and scanning motion, wherein each row of image patches is scanned in a pattern such that a first group of rows are scanned in a first horizontal direction and a second group of rows are scanned in a second horizontal direction opposite the first horizontal direction. A motion vector is determined for each image patch located in the scanned rows. Next, an image frame in the hierarchy having a next higher resolution is selected, the general direction of scan and the scanning motion are reversed, and the scanning and motion vector determining processes are repeated. The process continues until motion vectors have been determined for the image frame having the highest resolution in the resolution hierarchy. The motion vectors determined for the image patches located in the image frame having the highest resolution are then used as the motion vectors detected for the image frame.

In another embodiment of the present disclosure, the image frame having a lower resolution in the resolution hierarchy is selected and scanned in a general direction and scanning motion, wherein each column of image patches is scanned in a pattern such that a first group of columns are scanned in a first vertical direction and a second group of columns are scanned in a second vertical direction opposite the first vertical direction. A motion vector is determined for each image patch located in the scanned columns. Next, an image frame in the hierarchy having a next higher resolution is selected, the general direction of scan and the scanning motion are reversed, and the scanning and motion vector determining processes are repeated. The process continues until motion vectors have been determined for the image frame having the highest resolution in the resolution hierarchy. The motion vectors determined for the image patches located in the image frame having the highest resolution are then used as the motion vectors detected for the image frame.

The foregoing and other features and advantages of the present disclosure will become further apparent from the following detailed description of the embodiments, read in conjunction with the accompanying drawings. The detailed description and drawings are merely illustrative of the disclosure, rather than limiting the scope of the invention as defined by the appended claims and equivalents thereof.

### BRIEF DESCRIPTION OF THE DRAWINGS

Embodiments are illustrated by way of example in the accompanying figures, in which like reference numbers indicate similar parts, and in which:

FIGS. 1A-1D illustrate various examples of a general direction of scan;

FIG. 2 illustrates scanning motions for two levels of a resolution hierarchy in accordance with an example embodiment of the present disclosure;

FIG. 3 illustrates a method for implementing an embodiment of the disclosed motion estimation system;

FIGS. 4A and 4B illustrate an example original image frame;

FIGS. 5A and 5B illustrate an example first copy of the original image frame illustrated in FIGS. 4A and 4B;

FIGS. 6A and 6B illustrate an example second copy of the original image frame illustrated in FIGS. 4A and 4B;

FIG. 7 illustrates an example embodiment of scanning parameters;

FIG. 8 illustrates an example embodiment of scanning parameters;

FIG. 9 illustrates a method for selecting a best motion vector for a scanned image patch;

FIG. 10 illustrates an example image frame and image patch in accordance with the method illustrated in FIG. 9;

FIG. 11 illustrates example vector candidates applied to an example scanned image frame;

FIG. 12 illustrates an example method for computing an error measurement value for the example vector candidates illustrated in FIG. 11;

FIG. 13 illustrates example update vectors determined for a best candidate vector selected from FIG. 12; and

FIGS. 14A and 14B illustrate example scanning parameters and updated example scanning parameters.

### DETAILED DESCRIPTION OF THE DRAWINGS

The present disclosure provides a system and method for detecting motion vectors using a recursive hierarchical process with a non-rasterized vector-scanning motion to reduce erroneous motion vectors in a digital video sequence. The disclosed system and method provides faster convergence and improved accuracy by converging motion vectors in multiple directions and minimizing erroneous motion vectors in the image sequence.

Generally, for motion compensated approaches to work, two basic assumptions are made with respect to the nature of the object motion: 1) moving objects have inertia, and 2) the moving objects are large. The first assumption implies that a motion vector will have a gradual change with respect to each frame in the digital video sequence. The second assumption implies that the vector field is generally smooth and has only a few object/background boundaries.

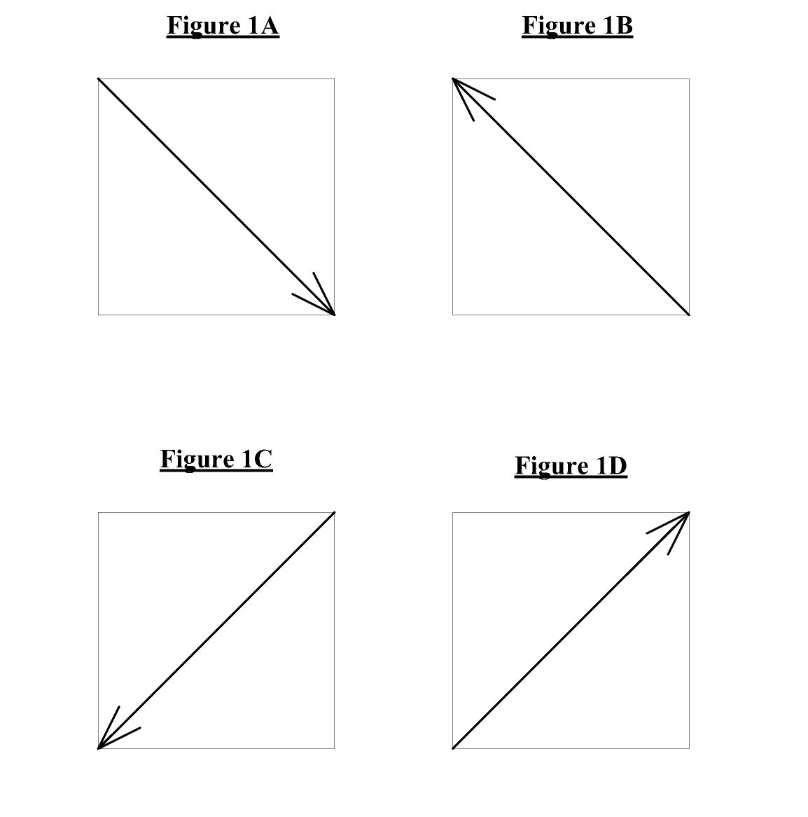

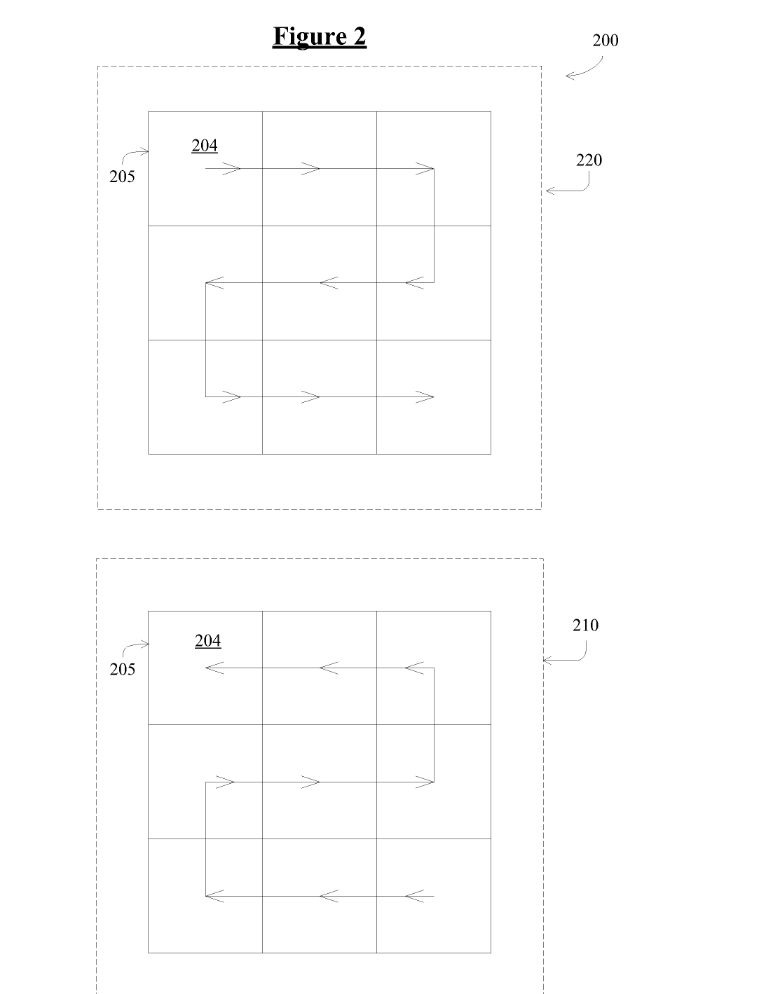

The goal of the disclosed motion estimation system and method is to detect motion vectors in an image frame of a digital video sequence while providing improved accuracy and faster convergence in contrast to conventional recursive hierarchical motion estimation systems. In the disclosed motion estimation system, motion vectors are determined for image patches scanned within a resolution hierarchy, wherein, for each level of the resolution hierarchy, the image patches are scanned in a general direction using a non-rasterized motion. As used in the present disclosure, a “general direction of scan” (otherwise referred to as a “general scanning direction”) refers to a global direction of scan for an image frame starting in one general location and concluding in another general location. The general scanning direction typically indicates the starting and ending origins of the scanning motion. Various examples of a general direction of scan are provided in FIGS. 1A-1D, wherein FIG. 1A is a general direction of top left corner to bottom right corner, FIG. 1B is a general direction of bottom right corner to top left corner, FIG. 1C is a general direction of top right corner to bottom left corner, and FIG. 1D is a general direction of bottom left corner to top right corner. Other general directions may include top row to bottom row, bottom row to top row, left column to right column, right column to left column, or any other direction that indicates a starting scanning origin and an ending scanning origin. It should be understood that, in some embodiments, the ending origin of the general direction of scan may be dependent upon the number of rows in the image frame. For example, a starting origin may be located in the top left corner of the image frame, and (depending on the number of rows in the image frame) an ending origin may be located at either the bottom left corner or bottom right corner of the image frame.

As used in the present disclosure, the term “scanning motion” refers to a pattern that defines the order in which image patches of an image frame are scanned. A scanning motion may include a rasterized motion or a non-rasterized motion. A “rasterized motion” refers to scanning rows of image patches sequentially, wherein each row is scanned in a same, single direction (for example, row-by-row, each row scanned from left-to-right). Accordingly, a “non-rasterized motion” refers to a pattern of scanning image patches other than in a rasterized motion. One example of a non-rasterized scanning motion may include a serpentine motion whereby the rows or columns of image patches are scanned in a “zigzag” pattern (for example, row-by-row, odd rows scanned left-to-right and even rows scanned right-to-left). Other examples of non-rasterized scanning motions may include patterns wherein a first group of rows or columns of image patches are scanned in a first horizontal or vertical direction and a second group of rows or columns of image patches are scanned in a second horizontal or vertical direction. In the present disclosure, a group of rows or columns may be classified as even rows or columns, odd rows or columns, or a number of selected rows or columns. It should be understood that the designation of odd and even rows or columns is not dependent upon the sequential order in which the rows or columns are scanned. In other words, each row or column of image patches in an image frame will be designated as either odd or even, and the designation will remain the same regardless of the order in which the rows or columns are scanned. It should be appreciated by those of ordinary skill in the art that certain aspects of the present disclosure, such as, for example, the general direction of scan and non-rasterized scanning motions, are not limited to the specific examples provided herein. Accordingly, various modifications and additions to the disclosed embodiments may be made without departing from the scope and spirit of the disclosure as defined by the appended claims.

As previously stated, the system and method of the present disclosure allows for image patches in a resolution hierarchy to be scanned in a non-rasterized motion, thereby providing faster convergence and greater accuracy than conventional recursive hierarchical motion estimation systems. The accuracy is further improved, and the convergence is further accelerated, by alternating, for each level in the hierarchy, the general scanning direction and/or the scanning motion, thereby scanning each image patch in multiple directions and thus converging the motion vector determined in each image patch in multiple directions. For example, as illustrated in the example embodiment 200 of FIG. 2, in a first level 210 of the hierarchy the image patches 204 of an image frame 205 are scanned in a first general direction (e.g., from the bottom right corner of the image frame 205 to the top left corner of the image frame 205) in a first serpentine scanning motion whereby odd rows of image patches 204 are scanned from right-to-left and even rows of image patches 204 are scanned from left-to-right. In a next level 220 of the hierarchy, the general direction of scan and the scanning motion are reversed such that the image frame 205 is scanned in a second general direction (i.e., from the top left corner of the image frame 205 to the bottom right corner of the image frame 205) opposite the first general direction and the rows are scanned in a second serpentine scanning motion whereby the odd rows are scanned from left-to-right and the even rows are scanned from right-to-left.

By reversing the general scanning direction and the scanning motion for resolution levels in the hierarchy, each image patch 204 is thereby scanned in multiple directions and the motion vectors determined for the image frame 205 having the highest resolution in the hierarchy will have been converged in multiple directions. When compared to a conventional recursive hierarchical motion estimation system using a rasterized scanning motion, the disclosed recursive hierarchical motion estimation system and method of using a non-rasterized scanning motion provides faster convergence, and the abundance of erroneous motion vectors that occur on one side of the object/background boundaries is greatly reduced, thereby achieving greater accuracy.

In accordance with the present disclosure, when reference is made to scanning an image patch in multiple directions, the image patch may be considered to be scanned in more than one direction (e.g., from left-to-right and from right-to-left) even if the different directions of scan occur at different resolution levels within the resolution hierarchy. Accordingly, when an image patch is scanned in multiple directions, the multiple directions of scan may not necessarily all occur within the same image frame in the resolution hierarchy. For example, as illustrated in FIG. 2, an image patch 204, such as the one located in the first column of the second row, may be scanned in one direction (i.e., from left-to-right) in the lowest level 210 of the resolution hierarchy, and then again in a second direction (i.e., from right-to-left) at another level 220 of the resolution hierarchy. Accordingly, the image patch 204 is considered to be scanned in multiple directions, and thus, any motion vector determined for the image patch 204 located at the highest level in the resolution hierarchy is considered to be converged in multiple directions.

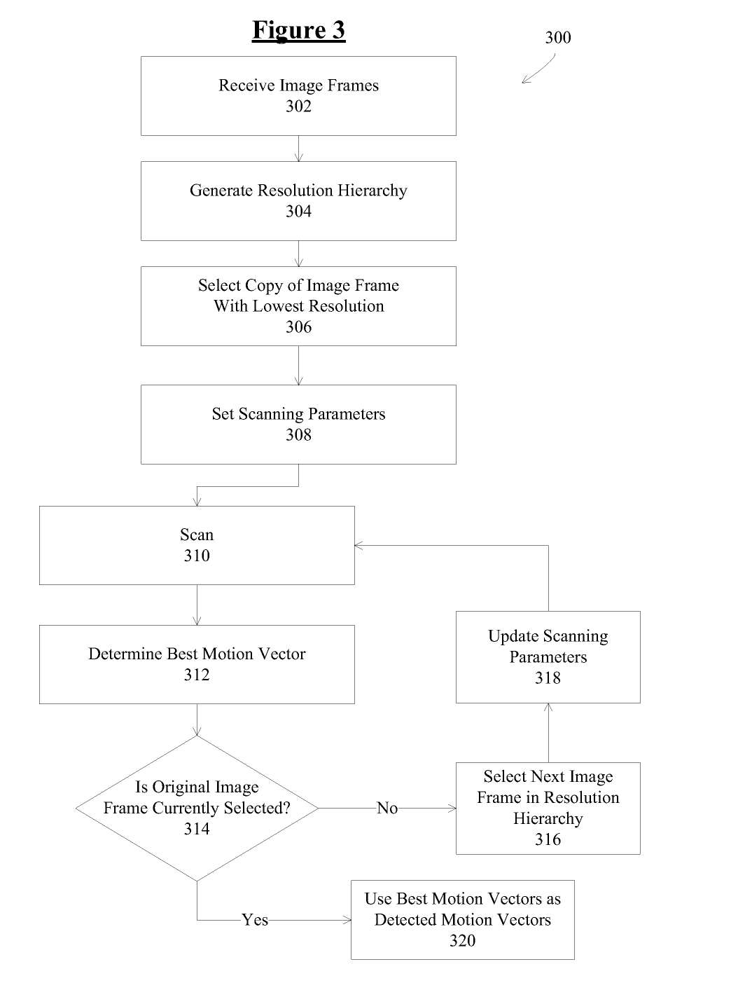

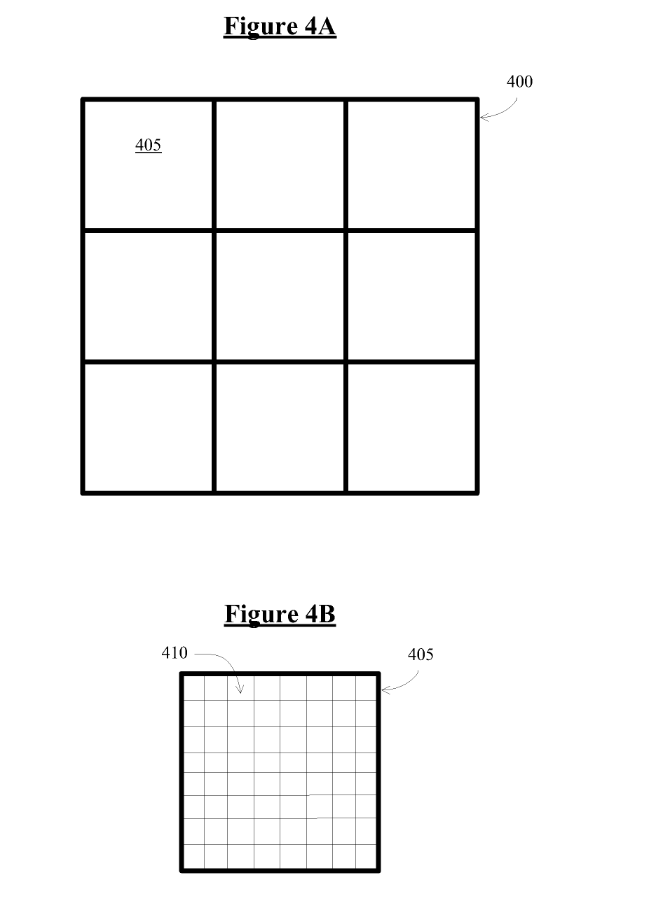

The disclosed motion estimation system and method are described in greater detail herein using FIGS. 3-14, wherein FIG. 3 provides a method 300 for implementing an embodiment of the disclosed motion estimation system, and FIGS. 4-8 and 14 provide example embodiments of the disclosed system to support the method 300 provided in FIG. 3.

As provided in step 302 of FIG. 3, two temporally displaced image frames are received from a digital video sequence, wherein the first image frame (otherwise referred to herein as the “original” image frame) is received having a first, original resolution, and the second image frame is an image frame temporally displaced from the first, or original, image frame. As explained in greater detail below, the second image frame generally provides a sequential image of the digital video sequence for comparison with the first image frame to detect motion between the first and second image frames. As such, in some embodiments a resolution hierarchy may be generated for the second image frame as further discussed below. It should be appreciated by those of ordinary skill in the art that the first and second image frames may be directly-sequential image frames (i.e., they are separated by no intermediate image frames) or they may be temporally-separated by one or more intermediate image frames.

FIG. 4A illustrates an example embodiment of an original image frame 400, wherein the original image frame 400 is comprised of image patches 405 arranged in columns and rows. As illustrated in FIG. 4B, each image patch 405 is comprised of groups of pixels 410, wherein the number of pixels 410 in an image patch 405 is dependent upon the resolution of the image frame 400. Although the image patches of the present disclosure are not limited to a specific size, in accordance with the example embodiment illustrated in FIGS. 4A and 4B, each image patch 405 in the image frame 400 is comprised of an 8×8 block of pixels 410.

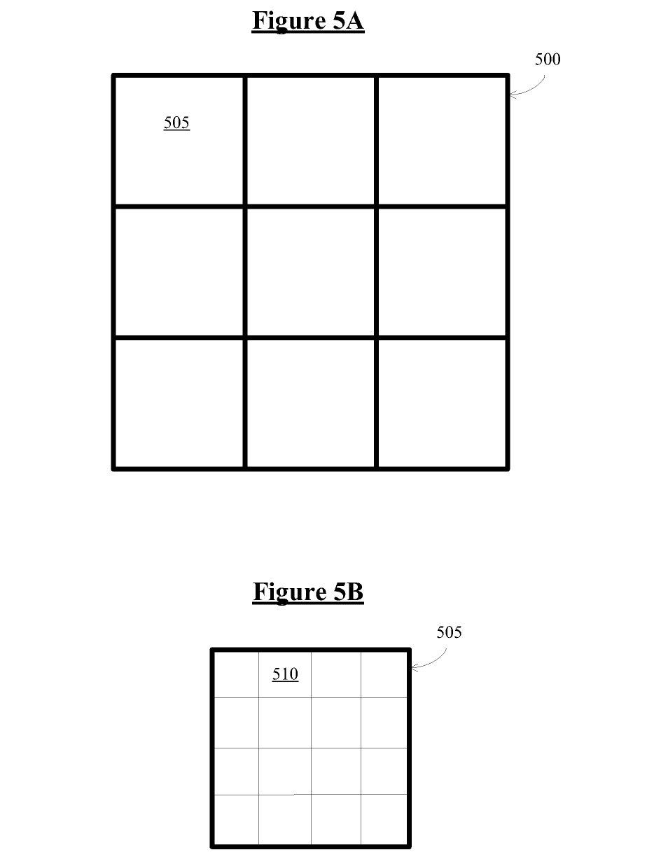

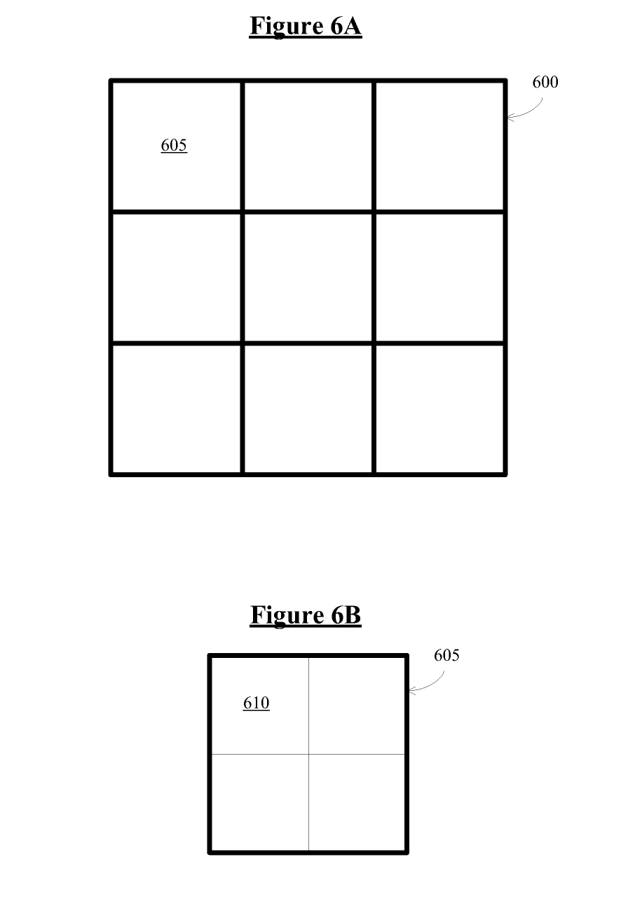

In step 304 of FIG. 3, copies of the original image frame 400 are created, each copy having a different, lower resolution than the original image frame 400, thereby generating a resolution hierarchy. In an embodiment of the present disclosure, FIG. 5A illustrates a first copy image frame 500, and FIG. 6A illustrates a second copy image frame 600. In general, the original image frame 400 and its respective copy image frames 500 and 600 form what is referred to herein as a resolution pyramid, or hierarchy, wherein the levels of the hierarchy are arranged in order of resolution starting at the top with the original image frame 400, or the image frame having the highest resolution, and ending at the bottom with the copy image frame having the lowest resolution. Although the resolution hierarchy of the disclosed system and method is not limited to a specific number of copy image frames, the example embodiments in FIGS. 4-6 provide a resolution hierarchy comprised of the original image frame 400 and the two copy image frames 500 and 600. As mentioned above, in some embodiments, a resolution hierarchy is also generated for the second image frame.

The first copy image frame 500 illustrated in FIG. 5A is comprised of image patches 505. FIG. 5B illustrates an example image patch 505 comprised of a 4×4 block of pixels 510, wherein the number of pixels 510 in the image patch 505 is dependent upon the resolution of the first copy image frame 500, as described below in greater detail. The second copy image frame 600 illustrated in FIG. 6A is comprised of image patches 605. FIG. 6B illustrates an example image patch 605 comprised of a 2×2 block of pixels 610, wherein the number of pixels 610 in the image patch 605 is dependent upon the resolution of the second copy image frame 600, which is also described below in greater detail.

As described above and illustrated in FIGS. 4-6, each image patch 405 in the original image frame 400 has an example resolution of 8×8 pixels 410, each image patch 505 in the first copy image frame 500 has an example resolution of 4×4 pixels 510, and each image patch 605 in the second copy image frame 600 has an example resolution of 2×2 pixels 610. Accordingly, the image patches 505 of the first copy image frame 500 have 1:4 resolution compared to the original image frame 400, and the image patches 605 of the second copy image frame 600 have 1:16 resolution compared to the original image frame 400. It should be understood that these resolution values are merely provided as examples to illustrate different embodiments of the present disclosure, and are not intended to indicate any limitation of the disclosed system and method.

In accordance with the example embodiments illustrated in FIGS. 4-6, image patch 505 has a lower resolution than image patch 405 of FIG. 4, and image patch 605 has a lower resolution than image patch 505. Accordingly, the first copy image frame 500 has a lower resolution than the original image frame 400, and the second copy image frame 600 has a lower resolution than the first image frame 500. Therefore, the resolution hierarchy for the example embodiments illustrated in FIGS. 4-6 is as follows: 1) second copy image frame 600 is the bottom, or first, level; 2) first copy image frame 500 is the middle, or second, level; and 3) original image frame 400 is the top, or last, level.

It should be appreciated that, in some embodiments, the image frames in a resolution hierarchy may have varying grid resolutions, whereby each image frame in the hierarchy may comprise a different number of rows and/or columns of image patches than other image frames in the hierarchy. However, as provided in the embodiment illustrated in FIGS. 5 and 6, the image frames in the resolution hierarchy have a uniform grid resolution, whereby each copy image frame 500 and 600 in the resolution hierarchy may be comprised of the same number of rows and columns of image patches as the original image frame 400 of the resolution hierarchy. Accordingly, the image patches 405 in the original image frame 400 correspond with the image patches 505 and 605 in each copy image frame 500 and 600 based on the respective position of each image patch in its respective image frame (copy or original). For example, an image patch 405 located in the second column of the third row of the original image frame 400 corresponds with each image patch 505 and 605 located in the second column of the third row for each copy image frame 500 and 600. Additionally, the image patches in the current resolution hierarchy may correspond similarly to image patches having the same relative location in other image frames in the digital video sequence such as, for example, the aforementioned second image frame.

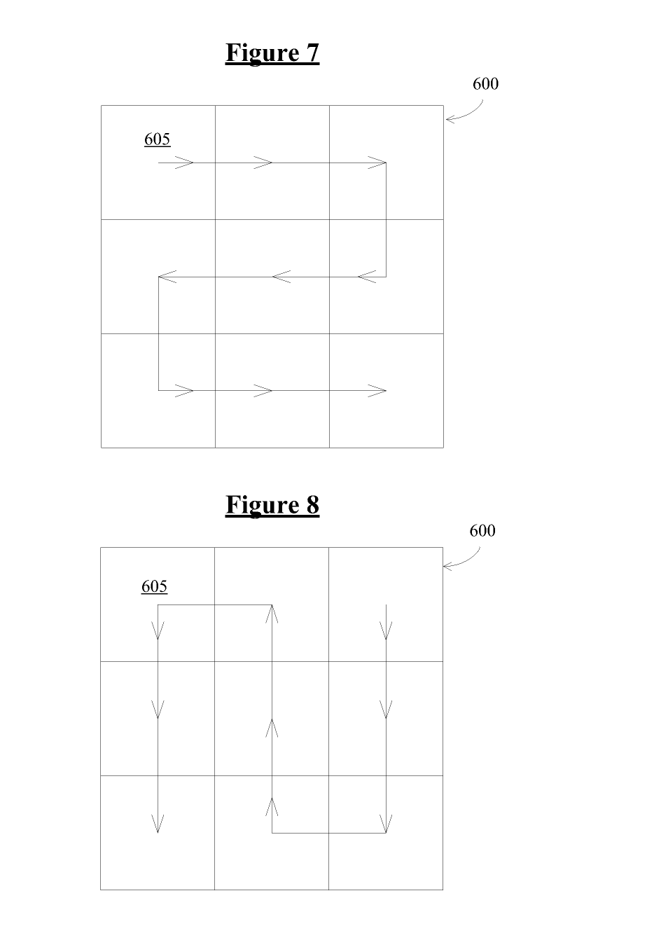

Referring back to FIG. 3, steps 306 and 308 teach selecting the copy image frame having the lowest resolution and setting the scanning parameters, respectively, for the resolution hierarchy generated for the original image frame 400. FIG. 7 illustrates the copy image frame selected in step 306, which, in accordance with the example embodiment illustrated in FIGS. 4-6, is the second copy image frame 600. The scanning parameters set in step 308 include the general direction of scan and the scanning motion. In the example embodiment illustrated in FIG. 7, the general direction of scan is from the top left corner of the second copy image frame 600 to the bottom right corner of the second copy image frame 600, and the scanning motion is a serpentine scanning motion whereby odd rows of image patches 605 are scanned from left-to-right and even rows of image patches 605 are scanned from right-to-left. The scanning parameters set in step 308 are not limited to those illustrated in FIG. 7 and described above. Accordingly, another example set of scanning parameters is illustrated in FIG. 8, wherein the general direction of scan is from the top right corner of the copy image frame 600 to the bottom left corner of the copy image frame 600, and the scanning motion is a serpentine scanning motion whereby odd columns of image patches 605 are scanned from top-to-bottom and even columns of image patches 605 are scanned from bottom-to-top.

In step 310 of FIG. 3, the image patches of the currently-selected image frame are scanned in accordance with the current scanning parameters—the scanning parameters that were most recently set or updated. For example, in accordance with the present example embodiment, if the currently-selected image frame is the second copy image frame 600 selected in step 306 (i.e., the image frame having the lowest resolution in the hierarchy), then the scanning parameters are those set in step 308 above. In accordance with the scanning parameters set above in step 308 and with reference to the example embodiment illustrated in FIG. 7, the general direction of scan is from the top left corner of the second copy image frame 600 to the bottom right corner of the second copy image frame 600, and the scanning motion is a serpentine motion. Accordingly, the top odd row of the second copy image frame 600 is first scanned from left-to-right. Next, the even row of the second copy image frame 600 is scanned from right-to-left. Finally, the bottom odd row of the second copy image frame 600 is scanned from left-to-right.

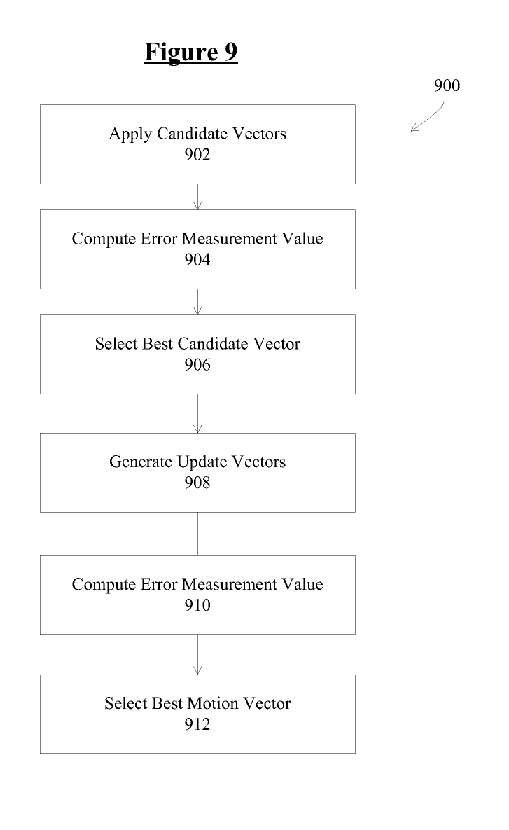

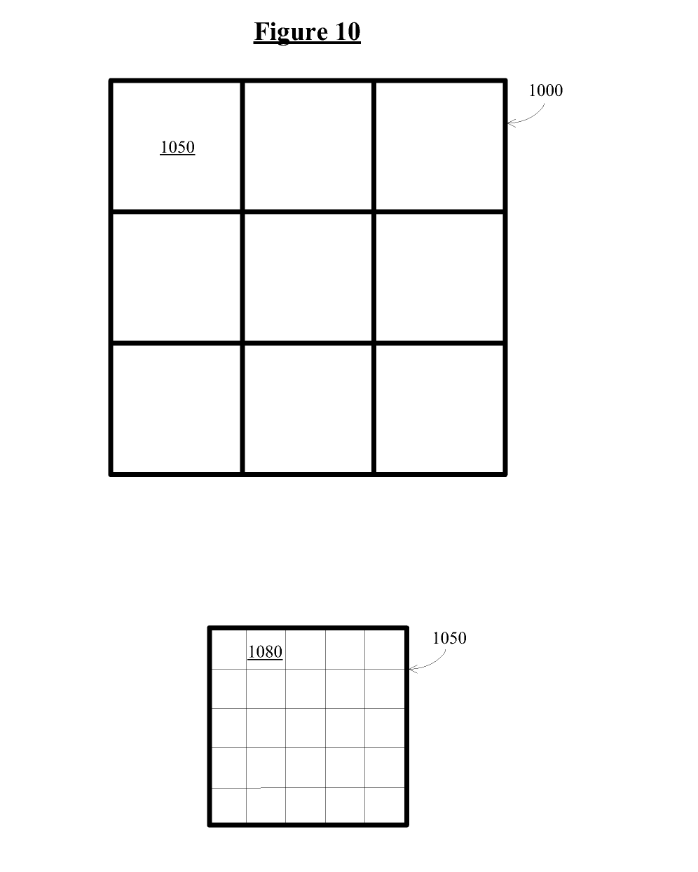

In step 312 of FIG. 3, a best motion vector is determined for each image patch 605 as it is scanned in step 310. FIG. 9 provides a flow chart 900 illustrating the steps involved in determining a best motion vector for an image patch 605 scanned in step 310. Additionally, example embodiments are provided in FIGS. 10-13 to illustrate the steps provided in the flow chart 900 of FIG. 9. Accordingly, FIG. 10 illustrates an example original image frame 1000 comprising scanned example image patches 1050. Each scanned image patch 1050 is comprised of a plurality of pixels 1080, wherein the number of pixels 1080 in a scanned image patch 1050 is dependent upon the resolution of the image frame 1000 in which the scanned image patch 1050 is located. The example scanned image patch 1050 illustrated in FIG. 10 contains a 5×5 grid of pixels 1080. Although the example image patch 1050 has a resolution of 5×5 pixels 1080, it should be understood that the resolution is an example resolution that is not intended to identify the example original image frame 1000 and example image patches 1050 as a particular image frame and image patches from FIGS. 4-8 having a particular resolution level in the hierarchy, but is intended to provide an example original image frame and example image patches to illustrate steps 902-912 of FIG. 9. Therefore, the principles and concepts applied to the example original image frame 1000 and example image patches 1050 illustrated in FIG. 10 may be applied to the appropriate image frame and image patches of the example embodiments illustrated in FIGS. 4-8, as well as to other embodiments not illustrated, without departing from the scope of the present disclosure as set forth in the appended claims.

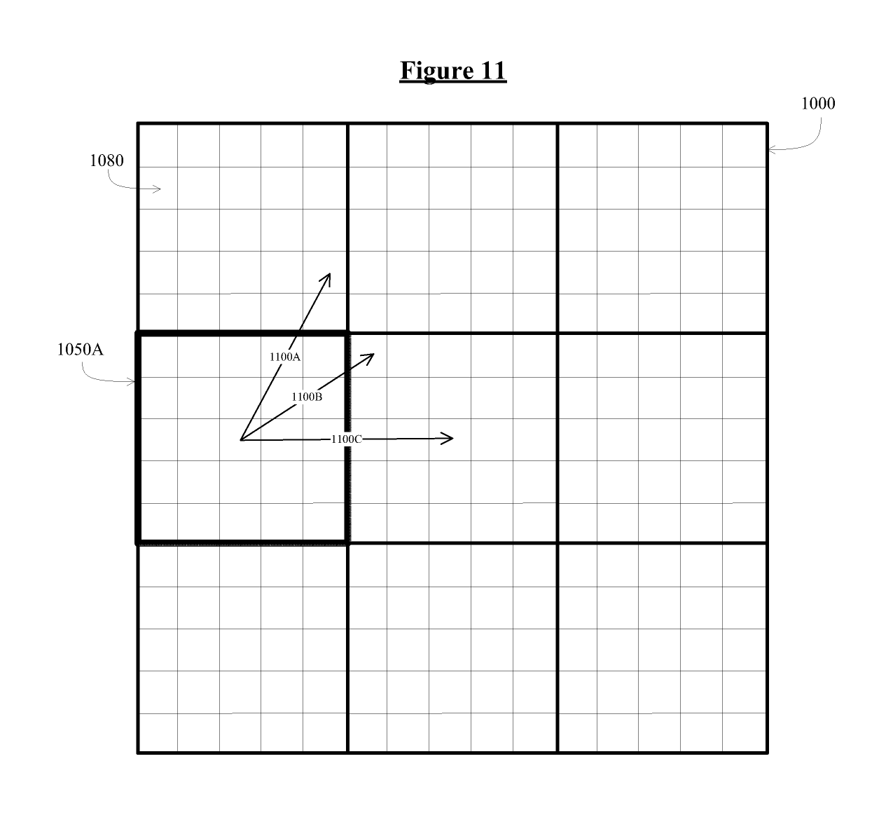

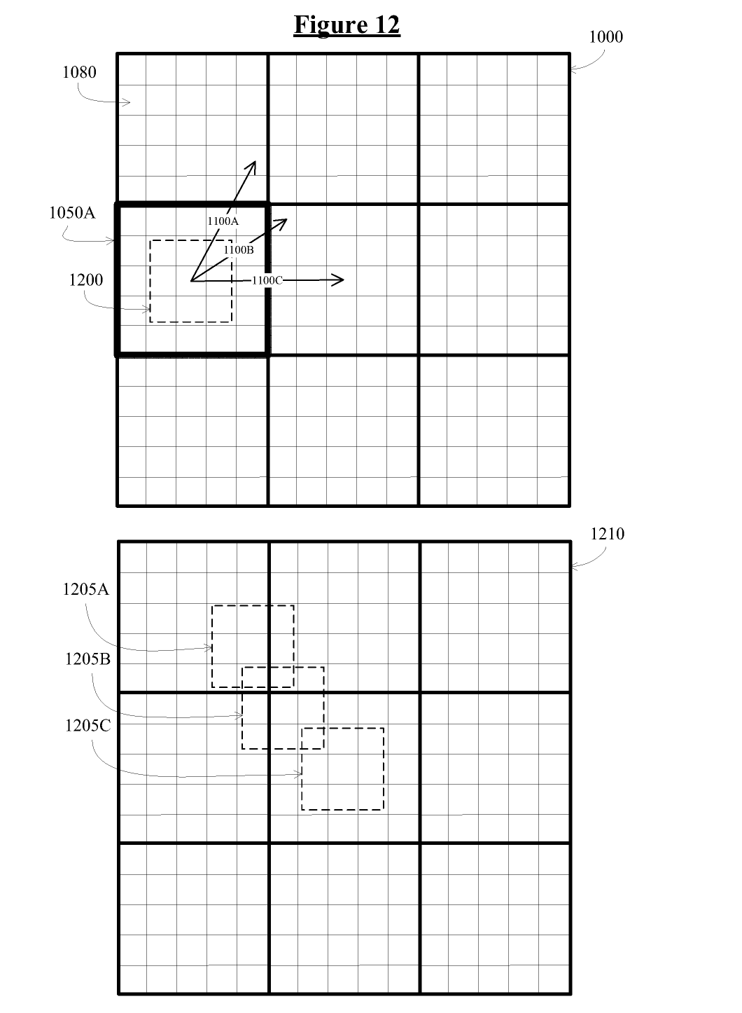

In step 902 of FIG. 9, a group of candidate vectors are applied to a scanned image patch 1050. The example embodiment provided in FIG. 11 illustrates the example original image frame 1000 having scanned image patches 1050. The example original image frame 1000 in FIG. 11 is shown with pixels 1080, and includes three example candidate vectors 1100A-1100C applied to an image patch 1050A located in the first column of the second row of image patches 1050. In the interest of clarity, the embodiments illustrated in FIGS. 11-13 only illustrate the candidate vectors applied to one image patch 1050A located in the image frame 1000. When reference is made to that specific, single image patch, reference numeral 1050A is used, and the specific, single image patch 1050A may be referred to herein as the “local image patch”. In the example embodiment illustrated in FIG. 11, the example candidate vectors 1100A-1100C originate from the pixel 1080 located in the center of the image patch 1050A, and end at various pixels 1080 located in adjacent image patches 1050; however, the disclosed system and method is not limited to the embodiment illustrated in FIG. 11. Accordingly, in other embodiments, the candidate vectors may originate from any pixel 1080 located in the image patch 1050A and may end at any pixel 1080 located in the image frame 1000.

In an embodiment of the present disclosure, a candidate vector may include a zero vector, a temporal candidate vector, a spatial vector, a hierarchical vector, a camera vector, or any other vector selected to provide a general indication of the direction of the motion vector to be determined for the scanned image patch 1050. As described in the present disclosure, a spatial vector is a best motion vector determined for a scanned image patch 1050 other than the local image patch 1050A, wherein the scanned image patch 1050 is located within the same resolution level of the current resolution hierarchy; a hierarchical vector is a best motion vector determined for a scanned image patch 1050 other than the local image patch 1050A, wherein the scanned image patch 1050 is located within a different resolution level in the current resolution hierarchy; a temporal candidate vector is a best motion vector obtained from an image patch located in a different resolution hierarchy (i.e., the resolution hierarchy of another image frame in the digital video sequence, wherein the other image frame is temporally displaced from the original image frame); and a camera vector is a motion vector that describes a global motion between sequential image frames in the digital video sequence.

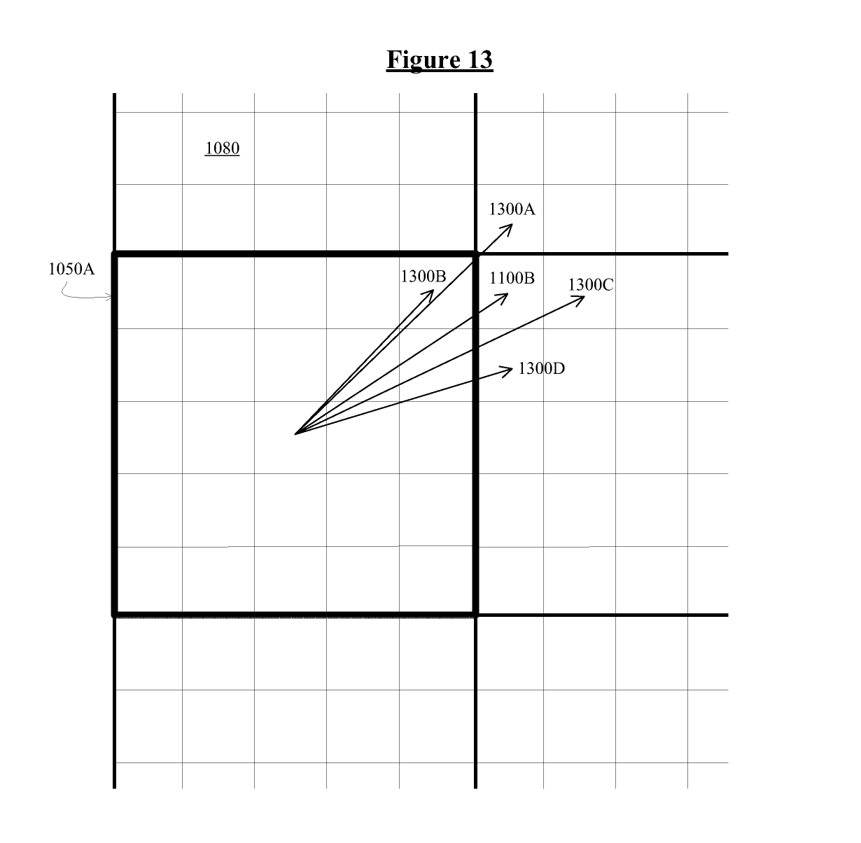

In step 904 of the method 900 illustrated in FIG. 9, an error measurement value is computed for the candidate vectors 1100A-1100C applied to the scanned image patch 1050A. Possible methods for calculating the error measurement value may include a block matching algorithm such as a sum of absolute differences (SAD), mean square difference, or any other error measurement method. In the implementation illustrated in FIG. 12, the error measurement value is computed using a SAD, whereby a rectangular window 1200 is centered around the origination point of candidate vectors 1100A-1100C located in the image frame 1000, and additional rectangular windows 1205A-1205C are created in a different image frame 1210, each centered around a point corresponding to the location of the end point of a candidate vector 1100A-1100C. As mentioned in the above discussion regarding the second image frame received in step 302 and the resolution hierarchy subsequently generated in step 304, the different image frame 1210 may be located in the resolution hierarchy of the second image frame in the digital video sequence, wherein the second image frame may be adjacent to the original image frame in the digital video sequence, or separated by one or more image frames.

As illustrated in FIG. 12, the end point window 1205 corresponding to a given vector candidate 1100 is labeled accordingly, wherein end point window 1205A is located in the different image frame 1210 at the location corresponding to the endpoint of candidate vector 1100A, end point window 1205B is located in the different image frame 1210 at the location corresponding to the endpoint of candidate vector 1100B, and end point window 1205C is located in the different image frame 1210 at the location corresponding to the endpoint of candidate vector 1100C. In the present embodiment, a pair wise absolute difference of the corresponding luma values of the pixels 1080 in the origination window 1200 and each end point window 1205A-1205C is calculated. In other words, the luma values of the pixels 1080 having the same relative location in the origination window 1200 and each end point window 1205A-1205C are compared to determine the absolute difference in luma value for each candidate vector 1100A-1100C. The sum of all the absolute differences for the pixels 1080 in the windows is the SAD value for each respective candidate vector 1100A-1100C. The SAD value decreases as the window matching improves and is ideally zero when the pixels 1080 in the origination window 1200 and a corresponding end point window 1205A-1205C are identical.

The windows 1200 and 1205 illustrated in FIG. 12 provide one example embodiment for determining an error measurement value using a SAD. Accordingly, other embodiments may be implemented to calculate an error measurement value for the vectors, wherein some embodiments may include other block matching algorithms, a mean square difference, or other methods of calculating an error measurement value without departing from the spirit and scope of the present disclosure as set forth in the claims below. For example, other methods of calculating an error measurement value may include using a block matching algorithm with windows of a varying sizes and shapes, or may include applying a weighting scheme for specific candidate vectors, whereby the error measurement value may be calculated by applying a weighted value to the error measurement value of each candidate vector. A weighting scheme may also be applied to any other error measurement methods (e.g., mean square difference, etc.) in order to calculate an error measurement value.

In step 906 of FIG. 9, the candidate vector having the lowest error measurement value is selected as the best candidate vector. In accordance with the present disclosure, the term “accuracy” may be used as an indication of error measurement, wherein the lower the error measurement value, the greater the accuracy. Therefore, a candidate vector having the lowest error measurement value may be referred to as the most accurate candidate vector. In accordance with the present embodiment of the disclosure, example candidate vector 1100B is selected in step 906 as the best candidate vector.

As indicated by FIG. 9, update vectors are generated in step 908 using the best candidate vector selected in step 906 (i.e., candidate vector 1100B). As illustrated in the present embodiment shown in FIG. 13, update vectors 1300A-1300D are generated for candidate vector 1100B. The set of update vectors 1300A-1300D are generally more accurate than the set of candidate vectors 1100A-1100C provided in step 902. Since, in the present embodiment, candidate vector 1100B was selected in step 906 as the best vector of the candidate vectors 1100A-1100C, the update vectors 1300A-1300D are generated within close proximity of candidate vector 1100B to determine if one of the update vectors 1300A-1300D may provide a more accurate motion vector than the best candidate vector 1100B.

In the example embodiment illustrated in FIG. 13, update vectors 1300A-1300D are generated by performing a dither of ±1 pixel 1080 to generate update vectors 1300A-1300D having an end point offset by one pixel 1080 in the horizontal or vertical direction relative to the end point of the best candidate vector 1100B. The pixel offset may otherwise be referred to herein as pixel motion, wherein the pixel motion may indicate the magnitude of the pixel offset. It should be understood that the number of update vectors and the process of generating update vectors are not limited to those described and illustrated herein. Accordingly, a greater or lesser number of update vectors may be generated wherein the update vectors may have an offset greater or less than that disclosed herein without departing from the spirit and scope of the claims as set forth below. For example, update vectors may be generated having an offset of ±2 pixels, ±0.5 pixels, etc.

In step 910 of FIG. 9, an error measurement value is computed, as discussed above, for the best candidate vector 1100B and the update vectors 1300A-1300D to determine the vector having the lowest error measurement value. The vector having the lowest error measurement value among the best candidate vector 1100B and update vectors 1300A-1300D is selected as the best motion vector in step 912 of FIG. 9. Accordingly, the best motion vector selected in step 912 is the best motion vector determined in step 312 of FIG. 3. Steps 908-912 may be referred to herein as performing a “vector update.”

Selecting a best motion vector from the best candidate vector 1100B and the update vectors 1300A-1300D provides a more accurate best motion vector for that resolution level. As briefly discussed above, the best motion vector may be applied to a set of candidate vectors generated for a different image patch 1050 as a spatial candidate vector, a hierarchical candidate vector, or a temporal candidate vector. If the best motion vector is applied as a spatial candidate vector, the different image patch 1050 is located within the same image frame 1000 of the current image resolution hierarchy. If the best motion vector is applied as a hierarchical candidate vector, the different image patch 1050 is located within a different image frame 1000 of the current image resolution hierarchy. If the best motion vector is applied as a temporal candidate vector, the different image patch 1050 is located in an image frame in a different resolution hierarchy.

A given pixel motion convergence may be achieved in a given image frame of a resolution hierarchy, wherein the pixel motion convergence is dependent upon the vector updates and the candidate vectors used in each image frame. As such, it should be understood by one of ordinary skill in the art, that performing vector updates in a resolution hierarchy allows for accelerated convergence with a fewer number of vector updates when compared to a non-hierarchical method.

Referring back to FIG. 3, step 314 involves checking if the currently selected image frame is the image frame having the highest resolution in the hierarchy, or, the original image frame 400. If the original image frame 400 is not the currently selected image frame, then the image frame having the next higher resolution in the hierarchy is selected in step 316, and the scanning parameters are updated in step 318. Updating the scanning parameters may include reversing the general direction of scan and/or alternating the scanning motion such that the updated scanning parameters provides a second direction of scan for each image patch in the resolution hierarchy. In accordance with an example embodiment of the present disclosure, if the currently selected image frame is the second copy image frame 600, then in step 316, the first copy image frame 500 is selected as the next image frame in the resolution hierarchy.

It should be understood that the steps provided in the present disclosure are not limited to the embodiment illustrated in FIG. 3 and described herein. For example, in other embodiments, step 314 may involve checking to see if the currently selected image frame is an image frame matching any of the image frames in the resolution hierarchy, and not just the original image frame. For example, step 314 may check to see if the second image frame in the resolution hierarchy is selected.

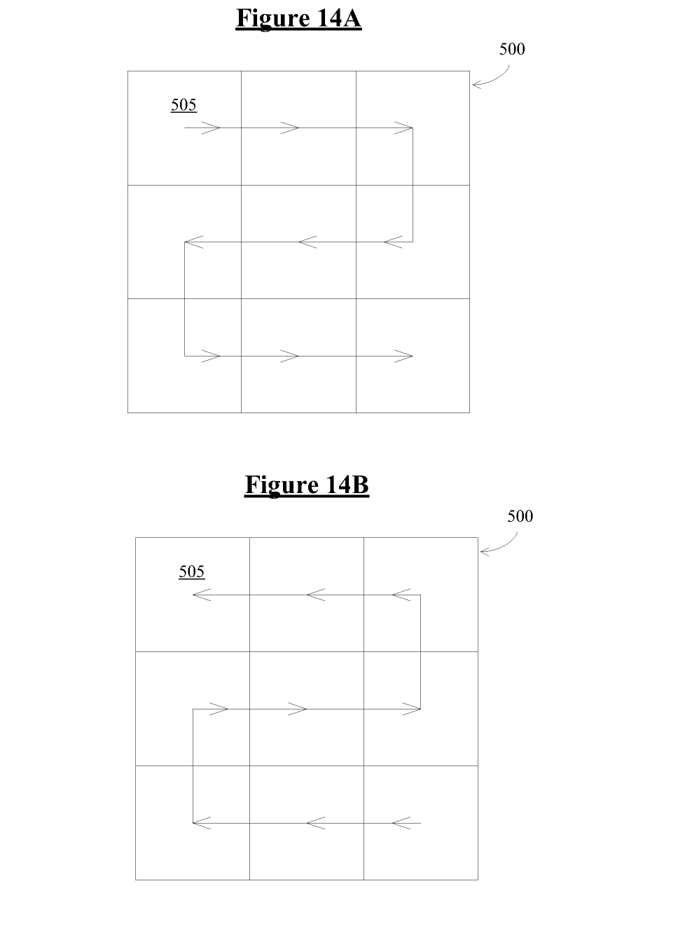

FIGS. 14A and 14B illustrate the image frame 500 selected in step 316 in accordance with the example embodiment provided in FIG. 3, wherein the general direction of scan and scanning motion set prior to step 318 in FIG. 3 is illustrated in FIG. 14A and the scanning parameters set in step 318 are illustrated in FIG. 14B. After selecting the next image frame in step 316, but before updating the scanning parameters in step 318, the example embodiment in FIG. 14A illustrates the general direction of scan from the top left corner of the copy image frame 500 to the bottom right corner of the copy image frame 500, and the serpentine scanning motion whereby odd rows of image patches 505 are scanned from left-to-right and even rows of image patches 505 are scanned from right-to-left.

As illustrated in FIG. 14B, after the scanning parameters are updated in step 318, the general scan direction and scanning motion are reversed. Accordingly, the general direction of scan is set to scan from the bottom right corner of the copy image frame 500 to the top left corner of the copy image frame 500, and the serpentine scanning motion is set so that odd rows of image patches 505 are scanned from right-to-left and even rows of image patches 505 are scanned from left-to-right. It should be understood that the updated scanning parameters are not limited to those disclosed in the present embodiment, and may include any combination of general scanning direction and non-rasterized scanning motion. For example, the general scan direction may remain the same, or may be changed to scan from the bottom left corner to the top right corner of the copy image frame 500. Additionally, in other example embodiments, the scanning motion may be changed such that image patches 505 are scanned in order of columns instead of rows.

Steps 310-318 of FIG. 3 are repeated until the image frame being checked for in step 314 is determined to be the currently selected image frame. In accordance with the present embodiment, steps 310-318 of FIG. 3 are repeated until the original image frame 400, or the image frame having the highest resolution in the hierarchy, is determined to be the currently selected image frame in step 314. Once the original image frame 400 is determined to be the currently selected image frame in step 314 of FIG. 3, the best motion vectors determined for the image patches 405 in the original image frame 400 in step 312 are used as the motion vectors detected by the disclosed motion estimation system in step 320. Because the resolution hierarchy comprises one or more copy image frames, and the scanning parameters are set or updated after each image frame in the resolution hierarchy is selected, each image patch in the hierarchy will have been scanned in multiple directions by the time the desired image frame is detected in step 314. Therefore, the motion vectors detected for the image patches 405 located in the original image frame 400 will be converged in multiple directions thereby providing accurate motion vectors.

It should be appreciated by those of ordinary skill in the art that the steps described in the foregoing disclosure may be implemented in a system designed to implement the functions provided in accordance with FIGS. 3 and 9. As such, in one or more embodiments, each function may be implemented entirely, in part, or in combination as software operating within a processing environment and/or as an integrated circuit or collections of integrated circuits, or circuitry, configured to perform the functions disclosed herein.

What is claimed is:

1. A method for detecting motion vectors between two temporally displaced image frames in a digital video sequence, said method comprising:
creating a first image frame with image patches having a first resolution, said image patches disposed in columns and rows;
creating a second image frame with image patches having a second resolution, said image patches in the second image frame disposed in columns and rows;
scanning the image patches of the second image frame in a first direction and generating a first best motion vector for each scanned image patch; and
scanning the image patches of the first image frame in a second direction and generating for each scanned image patch a second best motion vector from a group of candidate vectors including the first best motion vector.

2. The method as set forth in claim 1, wherein the second resolution is lower than the first resolution.

3. The method as set forth in claim 1, wherein scanning image patches in the first direction comprises scanning image patches in a first non-rasterized motion.

4. The method as set forth in claim 3, wherein scanning image patches in the second direction comprises scanning image patches in a second non-rasterized motion different than the first non-rasterized motion.

5. The method as set forth in claim 4, wherein:
scanning image patches in the first non-rasterized motion comprises scanning a first group of rows in a first horizontal direction and scanning a second group of rows in a second horizontal direction opposite the first horizontal direction; and
scanning image patches in the second non-rasterized motion comprises scanning the first group of rows in the second horizontal direction and scanning the second group of rows in the first horizontal direction.

6. The method as set forth in claim 5, wherein the first group of rows comprises odd rows of image patches and the second group of rows comprises even rows of image patches.

7. The method as set forth in claim 4, wherein:
scanning image patches in the first non-rasterized motion comprises scanning a first group of columns in a first vertical direction and scanning a second group of columns in a second vertical direction opposite the first vertical direction; and
scanning image patches in the second non-rasterized motion comprises scanning the first group of columns in the second vertical direction and scanning the second group of columns in the first vertical direction.

8. The method as set forth in claim 7, wherein the first group of columns comprises odd columns of image patches and the second group of columns comprises even columns of image patches.

9. The method as set forth in claim 1, wherein generating a first best motion vector for each scanned image patch comprises:
applying a first group of candidate vectors to a scanned image patch;
computing a first error measurement value for each candidate vector;
selecting, among the candidate vectors, the vector having the lowest first error measurement value as a first vector;
generating one or more update vectors;
computing a second error measurement value for the first vector and the one or more update vectors; and
selecting the one of the first vector and update vectors having the lowest second error measurement value as the first best motion vector for the scanned image patch.

10. The method as set forth in claim 9, said candidate vectors in said first group and said one or more update vectors indicating a potential best motion vector between said scanned image patch and an image patch located in a temporally displaced image frame.

11. The method as set forth in claim 9, wherein computing the first error measurement value comprises computing a sum of absolute differences value for each candidate vector.

12. The method as set forth in claim 9, wherein computing the first error measurement value further comprises applying a weighting scheme to the first error measurement value.

13. The method as set forth in claim 9, wherein computing the second error measurement value comprises computing a sum of absolute differences value for the first vector and the one or more update vectors.

14. The method as set forth in claim 9, wherein computing the second error measurement value further comprises applying a weighting scheme to the second error measurement value.

15. The method as set forth in claim 9, wherein the first group of candidate vectors comprises at least one of:
a temporal vector;
a hierarchical vector;
a camera vector;
a zero vector; and
a spatial vector.

16. The method as set forth in claim 9, wherein generating one or more update vectors comprises:
generating one or more vectors, each vector originating from the same pixel as the first vector and ending at a pixel having a horizontal or vertical offset from the end of the first vector.

17. The method as set forth in claim 1, wherein generating for each scanned image patch a second best motion vector comprises:
applying a second group of candidate vectors to a scanned image patch;
computing a first error measurement value for each candidate vector;
selecting, among the candidate vectors, the vector having the lowest first error measurement value as a first vector;
generating one or more update vectors;
computing a second error measurement value for the first vector and the one or more update vectors; and
selecting the one of the first vector and update vectors having the lowest second error measurement value as the second best motion vector for the scanned image patch.

18. The method as set forth in claim 17, said candidate vectors in said second group and said one or more update vectors indicating a potential best motion vector between said scanned image patch and an image patch located in a temporally displaced image frame.

19. The method as set forth in claim 17, wherein computing the first error measurement value comprises computing a sum of absolute differences value for each candidate vector.

20. The method as set forth in claim 17, wherein computing the first error measurement value further comprises applying a weighting scheme to the first error measurement value.

21. The method as set forth in claim 17, wherein computing the second error measurement value comprises computing a sum of absolute differences value for the first vector and the one or more update vectors.

22. The method as set forth in claim 17, wherein computing the second error measurement value further comprises applying a weighting scheme to the second error measurement value.

23. The method as set forth in claim 17, wherein the second group of candidate vectors comprises at least one of:
a temporal vector;
a first best motion vector;
a hierarchical vector;
a camera vector
a zero vector; and
a spatial vector.

24. The method as set forth in claim 17, wherein generating one or more update vectors comprises:
generating one or more vectors, each vector originating from the same pixel as the first vector and ending at a pixel having a horizontal or vertical offset from the end of the first vector.

25. A motion estimation system adapted to detect motion vectors between two temporally displaced image frames in a digital video sequence, said system comprising:
receiving circuitry adaptable to receive a first image frame with image patches having a first resolution, said image patches disposed in columns and rows, and a second image frame, said second image frame temporally displaced from said first image frame;
resolution hierarchy circuitry adaptable to generate one or more copies of said first and said second image frames;
selecting circuitry adaptable to select at least one of said first image frame or a copy of said first image frame;
scanning circuitry adaptable to perform at least one of setting scanning parameters or updating scanning parameters, said scanning circuitry further adaptable to scan image patches of said selected image frame in a first non-rasterized motion and a second non-rasterized motion different than said first non-rasterized motion;
motion vector circuitry adaptable to generate a first best motion vector for said scanned image patches;
image frame detection circuitry adaptable to detect the selected image frame; and
output circuitry adaptable to output a best motion vector detected for said first image frame.

26. The system as set forth in claim 25, wherein said motion vector circuitry further comprises:
candidate vector circuitry adaptable to apply one or more candidate vectors to a scanned image patch;
update vector circuitry adaptable to generate one or more update vectors; and
error measurement circuitry adaptable to compute an error measurement value for at least one of said one or more candidate vectors and one or more update vectors, said error measurement circuitry further adaptable to select at least one of the candidate vector or update vector having the lowest error measurement value.

27. An apparatus for detecting motion vectors between two temporally displaced image frames in a digital video sequence, said apparatus comprising:
a receiver adaptable to receive a first image frame and a second image frame, said first image frame comprising image patches having a first resolution;
a generator adaptable to generate one or more copies of said first and said second image frames;
a selector adaptable to select at least one of said first image frame or a copy of said first image frame;
a scanner adaptable to perform at least one of setting scanning parameters or updating scanning parameters, said scanner further adaptable to scan image patches of said selected image frame in a first non-rasterized motion and a second non-rasterized motion different than said first non-rasterized motion;
a motion vector generator adaptable to generate a first best motion vector for said scanned image patches;
a detector adaptable to detect the selected image frame; and
a device adaptable to output a best motion vector detected for said first image frame.

28. The apparatus as set forth in claim 27, wherein said motion vector generator further comprises:
a vector generator adaptable to apply at least one of one or more candidate vectors and one or more update vectors to a scanned image patch; and
an error detector adaptable to compute an error measurement value for at least one of said one or more candidate vectors and one or more update vectors, said error detector further adaptable to select at least one of the candidate vector or update vector having the lowest error measurement value.
